(19) United States
(12) Patent Application Publication
(10) Pub. No.: US 2020/0379458 A1
(43) Pub. Date: Dec. 3, 2020

(54) AUTONOMOUS SAFETY FOR PEDESTRIANS

(71) Applicant: EVEXIA RESEARCH, LLC, Newton Centre, MA (US)

(72) Inventor: Anthony Alexander Mckinney, Newton Centre, MA (US)

(73) Assignee: EVEXIA RESEARCH, LLC, Newton Centre, MA (US)

(21) Appl. No.: 16/900,807

(22) Filed: Jun. 12, 2020

Related U.S. Application Data
(63) Continuation-in-part of application No. 16/709,474, filed on Dec. 10, 2019.
Application No. 16/709,474 is a continuation of application No. 16/395,941, filed on Apr. 26, 2019, now abandoned.
Application No. 16/395,941 is a continuation of application No. 16/102,462, filed on Aug. 13, 2018, now abandoned.
Application No. 16/102,462 is a continuation of application No. 15/839,961, filed on Dec. 13, 2017, now abandoned.

(51) Int. Cl. G05D 1/00; B60Q 1/52; B60Q 5/00; B60Q 9/00; B60K 28/02; G08G 5/00; B60K 28/04; B60K 28/14

(52) U.S. Cl. CPC G05D 1/0055; B60Q 1/525; B60Q 5/006; B60Q 9/00; B60K 28/02; H04R 2499/13; G08G 5/0056; B60K 28/04; B60K 28/14; G05D 2201/021; G05D 2201/0213; G05D 1/0088

(57) ABSTRACT

The invention is a pedestrian safety method and system that compares characteristic acoustic and motion signatures to sound and motion signatures collected in real-time through a vehicle's monitoring system to detect and confirm that the vehicle itself presents a danger to pedestrians or others in proximity to the vehicle and autonomously stops the offending vehicle by quickly initiating disabling measures.

### CROSS-REFERENCE TO RELATED APPLICATIONS

This application is a continuation-in-part of U.S. application Ser. No. 16/709,474, filed Dec. 10, 2019, which is a continuation of U.S. application Ser. No. 16/395,941, filed Apr. 26, 2019, which is a continuation of U.S. application Ser. No. 16/102,462, filed Aug. 13, 2018, which is a continuation of U.S. application Ser. No. 15/839,961, filed Dec. 13, 2017, the contents of each of which are hereby incorporated by reference in its their entireties.

### FIELD OF THE INVENTION

This invention is related to systems and methods for providing pedestrian safety through the identification of vehicular threats using acoustic signatures combined with analysis of vehicle dynamics.

There have been attacks on pedestrians and bicyclists in public places by those in moving vehicles. Some of these attacks could have been preventable, or the aftermath less deadly. In many cases, pedestrians cannot escape due to narrow physical confines and the speed of the overtaking vehicle. In every case, as pedestrians attempted to escape, the nearfield sounds of panic, pedestrians being struck, bodies run over with a vehicle, and vehicles striking light metal structures (e.g., seating, tables, signage, bicycles) made a composite of sound characteristic of a vehicular attack (acoustic signature). Often, distinct acoustic signatures characteristic of a potentially impending vehicular attack within the vehicle may be captured prior to an attack via the internal vehicle monitoring systems. Another example of an early potentially predictive signature could be if the offending vehicle jumps a curb to access targeted pedestrians, which creates a distinctive acoustic signature combined with detectable change in vehicle dynamics due to the departure from the roadway and acceleration onto pedestrian-only walkways. During the vehicular pedestrian attacks in Nice (July 2016), Stockholm (April, 2017), London (June, 2017), Barcelona Spain (August 2017), and New York (October 2017) assailants wrested the vehicles sharply in order to run down pedestrians. These changes in vehicle dynamics can be tracked and recorded using accelerometry.

The systems and methods described herein detect danger to pedestrians by identifying characteristic acoustic and vehicle dynamic signatures indicative of an impending or actual vehicular attack emerging from outside and/or inside the vehicle and analyzing the signatures using proprietary pre-programmed parameters to rapidly assess the source and confirm the identity of the sound. Vehicle body motion can both anticipate an attack as well as confirm the source of the acoustic signature (self). Once confirmed, the system's kill switch transmits a signal to the electronic control module to disable the vehicle by stopping the engine, activating the brakes, and in specific embodiments of the invention, locking the doors and/or windows and notifying the authorities. The pedestrian safety systems and methods includes a tamper-resistance mechanism in certain embodiments. All elements of the systems of the invention are immune from outside takeover due to the autonomous nature of the system, which is designed to resist attempted intervention from an outside party attempting to access the system using an internet connection.

### DESCRIPTION OF THE RELATED ART

Current vehicles may use microphone circuits to “listen” to the local environment surrounding the vehicle, sounding an alarm if the vehicle is too close to an obstruction. Other vehicles “listen” to the local environment while the vehicle is backing up. These prior art pedestrian safety systems actually “listen” to protect pedestrians by using sound waves and/or at least one camera to determine whether there is a pedestrian within a specified distance to the vehicle. If a pedestrian is detected, the vehicle would send a warning to its driver such as a siren, light sequence, or other means of alert. One such system is described in CN 201210061606.

Vehicle proximity control is also available today, e.g., Takahashi and colleagues teach in US20040193351A1 that camera-based automatic braking systems can be designed into a new vehicle. These systems can warn the driver to stop the vehicle, or actually stop the vehicle remotely. A key difference between the systems of the invention described herein and those in US20040193351A1 is that the current systems and methods described herein are autonomous and embedded into the control systems of the vehicle itself. Operation of the vehicle, which has been deemed dangerous does not lie outside of the vehicle. Rather, a dangerous vehicle is brought to a rapid and safe stop using the autonomous system completely within the bounds of the vehicle itself and outside of the control of the driver, any occupant, or any other device or person outside of the dangerous vehicle. Waiting for intervention by authorities is not necessary so time to stop an attack is minimized.

The prior art methods and systems use energy at different frequencies (e.g., radar, infrared, visual light) as a means for determining proximity of the vehicle to an object by measuring the amount of time required for the energy to return to sensors found on the vehicle. The information provided is one of time and distance and is not specific to the type of object, or the specific threat. The systems in the prior art are not adapted to compare the sounds collected to sounds that have been determined to be indicative of impending or actual danger. In addition, the systems Takahashi describes utilize cameras to detect objects not sound patterns.

These are solutions to fundamentally different problems. The systems and methods of the invention are for broad implementation in new or retrofitting to used vehicles to monitor a vehicle for active intent to harm. When activated, the claimed systems renders the vehicle inoperative and may impede the escape of the driver and contact the authorities in specific embodiments of the invention. By rendering the vehicle inoperative, the system enables the vehicle to be maintained under control for collection of evidence by the authorities.

There are other patents that disclose related warning sounds, such as Patent Application No. 200910147446.6, which discloses a hybrid voice warning system. These prior art systems are focused on providing sound alerts to the driver of the vehicle. As such, the systems have the following disadvantages: at low speeds require a warning sound; does not consider the effects of environmental noise on the warning sound generation in order to increase impact of the message; warning sound does not reflect the speed and acceleration of the vehicle condition information; and pedestrian detection module is not included so timely and specific reminder of pedestrians is not provided. The most notable disadvantage of all existing systems is that they all rely on the driver to be willing and able to stop the vehicles in response to warning signals. In an event where a driver purposefully intends to cause harm to pedestrians, none of the prior art systems would be suitable to reduce the loss of life.

The presently claimed inventions avoids these disadvantages because the acceleration of the offending vehicle is not controlled by the driver once the criteria have been met to identify the vehicle as a threat. Once the vehicle has been seemed dangerous to pedestrians, control of the vehicle is removed from driver and transferred to a kill switch based upon pre-programmed parameters stored within the kill switch. There is no need to install additional means for capturing sound or motion detection. The systems and methods described herein rely on existing sound capturing mechanisms already built into most vehicles. In vehicles that do not have built-in microphone systems, these technologies can easily be retrofitted and connected into the control systems of the vehicle. An accelerometer enabled motion-detection module is embedded into the system CPU and installed into the vehicle.

Additionally, the systems and methods of the invention do not utilize cameras like prior art systems. Using cameras require costly structural hardware, which would be an impediment to wide implementation.

There are systems contemplated in the prior art that allow remote disablement of a vehicle's acceleration, such as the systems contemplated in CA 2674662 A1 and U.S. Pat. No. 5,933,075 A. The system described therein remotely disables the acceleration without disabling the ignition of the motor vehicle for anti-chase purposes. The system described therein does not initiate braking. The system described therein also does not rely upon acoustic nor accelerometer signatures to autonomously control the acceleration and braking of the vehicle, but instead requires law enforcement to identify the VIN and color code information during a chase, and sending a wireless signal to sever the electronic connection between the accelerator pedal and the vehicle control systems.

These systems do not address the problem addressed by the systems and methods described herein because the systems described in CA 2674662 A1 require law enforcement to have awareness and close proximity to the offending vehicle in order control the vehicle's acceleration. In most cases of deliberate or accidental harm to pedestrians, law enforcement is not aware or close to the offending vehicle prior to the attack.

The methods described in the prior art also only result in a deceleration of the vehicle due to the nature of most chases. As such, there still remains a need for an autonomous pedestrian safety system that is low cost, easy to integrate into existing vehicles, and most important, specifically designed to address deliberate vehicular attacks. The methods and system of the present invention would quickly stop the offending vehicle to avoid or minimize contact between the vehicle and pedestrians. As used herein, “pedestrian” includes any person in public that is not inside a vehicle.

### SUMMARY

The pedestrian safety systems of the invention identify and mitigate impending vehicle threats using systems having permanently stored, pre-loaded acoustic and vehicle body motion signatures characteristic of vehicular attack. The system uses the vehicle's monitoring system and modified as needed to collect, analyze and compare the incoming acoustic and body motion data to stored known signatures to ascertain whether there is an impending immediate threat. The system includes housing means adapted to connect the kill switch, storage means and receiver to one another, allow an incumbent connection to a vehicular power source for the system and provide a communicable connection between the vehicle electrical control module and the system.

### BRIEF DESCRIPTION OF THE DRAWINGS

FIG. 1 provides a high-level overview of the product, with up to six data streams to make decisions and send out an output to a vehicle that would initiate certain actions to stop it from moving (such as turning on the engine and enabling the brakes).

FIG. 2 provides a general process for automated decision-making, using data streams as depicted in FIG. 1.

FIG. 3 depicts a schematic system design, utilizing accelerometer and microphone data, wherein the processor is a digital micro-computer, such as an ARM processor capable of running Linux. In this figure,
ADC: Analog to Digital Converter
FT: Fast Fourier Transform
Conv: Convolution
PID: On-board diagnostics Parameter ID

FIG. 4 depicts a schematic system design utilizing data streams in addition to those depicted in FIG. 3.

FIG. 5 depicts an alternative schematic system design, utilizing at least microphone and accelerometer data streams, wherein the processing is controlled by a determination algorithm, for example a machine learning algorithm.

FIG. 6 depicts an alternative schematic design, using a field-programmable gate array (FPGA), so there is no need to turn the microphone or accelerometer data into digital signals.

FIG. 7 depicts a schematic design combining elements of the different alternatives above.

### DETAILED DESCRIPTION

With reference to the Figures, and in one embodiment of the invention, the pedestrian safety systems and methods of the invention, utilize a storage means to permanently store a compilation of characteristic sound waveforms (“acoustic signatures”) that are indicative of an impending or actual vehicular attack (“characteristic acoustic signatures”). The storage means comprises a non-volatile memory array configured adapted to store information for use by the various components of the invention. The characteristic acoustic signatures are pre-loaded and stored into the storage means, which is adapted to store the characteristic acoustic signatures permanently, which will be used to identify potential threats, as well as sound waveforms and related present acoustic signatures that are continually received from the vehicle's monitoring system. The sound waveforms will be stored temporarily by the storage means for comparison with the characteristic acoustic signatures using proprietary algorithms.

Characteristic acoustic signatures that may be permanently pre-loaded into the storage means are those indicating vehicular attacks, including but not limited to the sound waveforms originating inside a vehicle indicating an attack could be imminent, e.g. human voices saying specific words or phrases plus external sounds, for example, sound waveforms related to a vehicle accelerating, departing a roadway then the sound of the vehicle traversing a curb to access a pedestrian-only space, plus sound waveforms resulting from the vehicle impacting structures or pedestrians, i.e., waveforms of human voice expressing fear, panic or pain, or light weight metals being struck at high speed.

These sounds together form a composite of sound wave forms that create a characteristic acoustic signature with a temporal sequence and set of frequencies associated with events that map to sounds and actions by the assailant. As used herein, “vehicle” includes any device that transports people, animals, or goods from one place to another.

In the recent European (Stockholm, Nice, London, and Barcelona) and US (New York) attacks, among other examples, the assailant vehicles sought to strike as many pedestrians as possible. This may be related to al Qaeda guidance in a 2010 publication entitled “The Ultimate Mowing Machine.” The article called for using a truck as a “mowing machine, not to mow grass but mow down the enemies of Allah.” The article added, “To achieve maximum carnage, you need to pick up as much speed as you can while still retaining good control of your vehicle in order to maximize your inertia and be able to strike as many people as possible in your first run.”

Complying with this guidance means that assailant vehicles must go through major accelerations/decelerations and a number of directional changes. These high-speed changes in vehicle dynamics induce high rate G-force changes detectable with accelerometry. Impact with pedestrians or structures impacted in the pedestrian walkway also induce G-force changes detectable by the same motion detection system.

In certain specific embodiments of the system and methods of the invention, an additional non-optical monitoring means is employed. Another non-optical monitoring means is a shock absorber monitoring means. Any non-optical means for detecting impending danger may be used in accordance with the methods and systems of the invention. One skilled in the art could easily envision others, and those others are anticipated to be within the spirit and scope of the claimed invention.

For example, the characteristic violent vehicle body motion generated by jumping a curb, could be captured either by the attitude change of the vehicle or measuring the rate of change at the shock absorbers. A non-limiting example, would be the use of piezoelectric senders to measure the characteristic shock absorber motion of wheels transiting over curbs which could be used to signal an impending vehicular attack.

Another approach would be to embed a motion-detection module comprised of an accelerometer into the central processing unit of the main system to measure the violent body motion change when the vehicle body at rest (in space) is subject to movement when moving from a vehicle roadway to a pedestrian walkway. Either non-optical means for detecting impending danger could recognize these changes based on pre-programmed criteria, which are stored within the storage means, the receiver could process the data by comparing stored data indicating impending danger to the current information being gathered from the monitoring means and trigger the kill switch to disable the vehicle.

In the invention, this motion detection information acts in a synergistic way to temporally measure the initiation of the event and strengthen the validity of the acoustic signature information, i.e., in order for there to be the condition of pedestrians expressing fear, panic and pain induced by vehicular attack, vehicle dynamics data preceded this outcome. Individually, each sensor is not as strong, for example, a driver could simply have inadvertently run over a curb (but not pedestrians hence no triggering of the acoustic trigger) or driven past a carnival with children screaming (hence no high rate vehicular dynamics nor the other aural aspects of vehicular pedestrian attack, e.g., structures being struck). When used together, however, a synergistic using two independent sensors measuring two independent yet related phenomena provide a more reliable determination that a valid attack is taking place.

The system comprises a receiver in operable communication with the storage means, an accelerometer integrated in the central processing unit and the vehicle's microphones, which may be integral to the vehicle's monitoring system. It can be envisioned that vehicles without monitoring systems may nevertheless benefit from the systems and methods of the invention by adding microphones to the vehicle's acoustic and control systems. These microphones continually pick up sounds that are both internal and external to the vehicle. The sound waveforms, which may also be referred to as sounds, or soundwaves herein, that are continually received into the vehicle's monitoring system, via the integrated microphones, are identified and transmitted to the receiver through the vehicle's existing monitoring system. The receiver includes a central processing unit that is adapted to continually identify and receive sounds from the vehicle's microphones, process the sounds in accordance with pre-programmed parameters to continually monitor for the presence of an acoustic signal indicative of an impending threat, and transmit a distress signal to a kill switch when certain criteria are met that indicate an impending vehicular threat. As used herein, the “present” acoustic signature is the signature of the composite soundwave created by converting sounds picked up by the vehicle's monitoring systems continually, and not the characteristic acoustic signatures that are pre-loaded and stored in the storage means.

The receiver identifies sound waveforms using the vehicle's monitoring microphones, receives the sound waveforms and briefly stores those into the storage means for processing. Processing the acoustic signatures includes converting the sound waveforms received into a present acoustic signature and comparing the present acoustic signature to those permanently stored characteristic acoustic signatures in accordance with a pre-programmed parameter stored with the central processing unit of the receiver.

The receiver identifies high gain vehicle dynamics using the vehicle's monitoring accelerometer, receives the motion waveforms and briefly stores those into the storage means for processing. Processing the vehicle motion signatures includes converting the motion waveforms received into a present motion signature and comparing the present motion signature to those permanently stored characteristic motion signatures in accordance with a pre-programmed parameter stored with the central processing unit of the receiver.

In accordance with the stored algorithm, if the present acoustic signature created is found to be closely associated with at least one permanently stored characteristic acoustic signature, i.e., deemed dangerous, and if the present motion signature created is found to be closely associated with at least one permanently stored characteristic motion signature, the receiver will transmit a distress signal to a kill switch, which is operably connected to the vehicle's electronic control module. After the acoustic and motion signatures are processed, they are discarded and not stored within the systems of the invention. However, in specific embodiments of the invention, any present acoustic or motion signature that is deemed a match with a characteristic acoustic or motion signature is stored for later analysis.

Once the distress signal is transmitted to the kill switch, it will in turn communicate with the electronic control module to disable the vehicle. The kill switch of the invention is adapted to communicate with the electronic control module to direct it to alter the vehicle's control to bring the vehicle to a safe stop by transmitting a signal to initiate braking and disabling throttle capability to minimize the loss of life. The pre-programmed parameters are specifically adapted to transmit instructions to the electronic control module ensure the safest and quickest stop necessary to minimize the loss of life.

The electronic control module generally controls all of the vehicle's components, including but not limited to the braking system, locking system, and the vehicle's throttle control. In a specific embodiment of the invention, the electronic control module is the vehicle's black box. Algorithms are employed to trigger activation of the braking system and interrupt driver control of the throttle to bring the vehicle to a stop autonomously.

These algorithms are pre-loaded into the system in accordance with the invention, unable to be modified by a driver or vehicle occupant. The system and methods of the invention are best suited for use in vehicles operating at speeds where rapid deceleration is physically possible, e.g., road vehicles including but not limited to automobiles, buses, mining machines, trains, or trucks. Other applications such as airplanes where vehicle kinetics cannot be safely arrested in time to prevent harm, may instead use the invention to redirect the landing.

All elements of the systems of the invention are in operable communication with one another and housed in a housing means that is specifically adapted to allow an incumbent connection to a vehicular power source for the system, to provide a communicable connection between the vehicle's monitoring system and the receiver of the invention, and to enable communication between the systems' kill switch and the vehicle's electronic control module.

The systems of the invention do not rely on cameras to determine whether there is an impending threat to human life, determine distance, or to determine if the vehicle poses a threat. The systems and methods of the invention rely solely on acoustic signatures and vehicular dynamics to determine whether a threat exists and then act autonomously.

In one embodiment of the invention, the storage means is a digital memory storage device employed to contain the non-volatile and volatile information necessary to the employ the system. Any non-volatile computer-type storage that encodes and retrieves digital information using only electronic circuits, without any involvement of moving mechanical parts may be employed in accordance with the invention. In accordance with the various systems and methods of the invention, various types of form factors, storage-space sizes, and interfacing options may be employed without departing from the spirit and scope of this invention. In specific embodiments of the invention, the solid-state storage device is one of a multimedia card, secure digital memory card, solid-state drive, USB flash drive, drum memory, I-RAM, magnetic storage media, RAM drive, sequential access memory device, or a wear leveling device.

The housing means is a storage device employed to house all of the elements of the claimed systems. The system is also protected by a hard-shell casing in other specific embodiments of the invention. The hard-shell casing is about the periphery of the housing means to protect the housing means from external damage and tampering. The casing should not obstruct the connectivity of the solid-state storage device to the vehicle.

In certain embodiments of the invention, the kill switch is adapted to transmit a signal to the electronic control module that overrides the driver foot position and places the vehicle throttle position at idle and cannot be overridden regardless of driver action. The vehicle engine remains at idle therefore the braking system remains fully energized.

In certain embodiments of the invention the kill switch is adapted to transmit a signal to the electronic control module directing it to lock the doors and windows to prevent driver exit. In other specific embodiments of the invention, the kill switch is adapted to transmit a signal to the electronic control module directing it to automatically transmit an emergency signal to safety authorities, or an emergency number, e.g. 911 with transmission of an automated message, to report the incident, when the kill switch is triggered.

Some existing technologies use microphone circuits to “listen” to the local environment surrounding the vehicle, e.g., while reversing or if the vehicle is too close to an obstruction. The “listening” in these prior art devices does not involve comparing acoustic signatures like the current receivers described herein. In prior art devices, energy or acoustic signals are used to judge distance between the vehicle and another object. The systems and methods claimed herein identify and receive sounds and process the sounds by comparing them to characteristic acoustic signatures that are stored within the system itself. Combining motion detection of the vehicle adds additional signal strength by anticipating the acoustic event and bringing accelometry data into the decision to trigger the kill switch. Incorporating the systems and methods of the invention into the existing listening circuit technology allows autonomous disabling of the throttle and activation of the brakes, thus stopping the vehicle if the vehicle monitoring system “hears” the characteristic acoustic signatures and “feels” the characteristic vehicle dynamics of a vehicular strike.

The kill switch of the invention does not itself stop the brakes or disable the throttle. The system algorithms compare the arrival times, direction, and proximity of the present sound waveforms, and then determines that the one or more of the triggering acoustic signature sound waveforms are present. If an accompanying vehicle dynamics signature is present, the kill switch sends a signal to the vehicle electronic control module, to effectuate the disabling of the throttle based upon pre-determined parameters stored within the kill switch. In accordance with the presently claimed methods and systems, the vehicle's acceleration would be rapidly reduced if the system's parameters were met, demonstrating that the vehicle itself is the point source by the use of time, signal-strength, and directional vector-based algorithms to exclude other vehicles. System microphones picking up signals from the vehicle itself will arrive on a direct path faster, and with more signal strength than those from another vehicle where they would be indirect (i.e., slower) and with less signal strength. The pre-programmed triggering parameters must have the characteristic sound signature with the correct proximity, strength, and directionality combined with the accompanying vehicle dynamics signature when reaching the decision whether or not to arrest the vehicle. Thus, another vehicle following directly behind the offending vehicle may detect characteristic sound waveforms and directionality but fail the proximity detection (and vehicle dynamics test) and thus be able to proceed.

Upon activation, and in one embodiment of the invention, the system's kill switch would direct, through an electronic transmission, the vehicle electronic control module, to lock the vehicle to prevent the offending driver from leaving the scene so that authorities can ensure the assailant is captured and the vehicle is maintained intact.

The kill switch of the invention is responsive to characteristic sound waveforms and related sound maps that are compiled in the storage means and identified by the receiver. Similarly, the system is responsive to characteristic vehicle dynamics maps that are compiled in the storage means. The storage means is local and resides within the system. The systems of the invention do not utilize or communicate with storage means that are integral to the vehicle, or any other storage means which may not be closed and is therefore subject to remote access. As used herein “closed” means fully contained within the vehicle and having no wireless communication external to the vehicle.

In specific embodiments of the invention, the system further includes an anti-tamper mechanism that renders the vehicle unable to drive if any component of the system is tampered with, or removal is attempted. In one embodiment, the vehicle is rendered undrivable by collapsing the vehicles operational circuit. Other means for rendering the vehicle unable to drive may be employed and are anticipated to be within the scope of the invention.

This technology could be initially retrofitted into rental vehicles but later incorporated into all vehicles, new or used, with the commensurate underlying technology. In the case of older vehicles, microphones and accelerometry could be installed in the vehicle as long as the vehicle is sufficiently modern to have an electronic control module.

The systems of the invention are autonomous and not accessible to the internet, Wi-Fi, or any other means of communication outside of the vehicle itself. This autonomous feature is key to the invention and prevents manipulation of the systems of the invention by remote actors. To provide further security, the holding means of the invention is encrypted so that when disengaged from the system, the characteristic systems and propriety pre-programmed parameters, are not accessible to a non-authorized user.

In specific embodiments of the invention, the kill switch directs the electronic control module to contact the authorities when it is triggered. In other embodiment of the invention, the kill switch of the invention directs the electronic control module to honk the horns, blink the lights, trigger the alarm (if available) or to provide other visual stimulus to warn pedestrians of danger.

In alternative embodiments of the invention, the system and methods detect the sounds of approaching emergency vehicles and trigger a dashboard warning or an audible warning, providing instructions to the driver. Additionally, other changes-in-state can be detected audibly (through the cabin microphone) or via the change in G-force via the vehicle dynamics accelerometer to determine the presence of a passenger (sleeping baby, for example) that warns the operator to check the vehicle for other occupants. Another example could be to prevent driverless movement (vehicle left in neutral or failure of the emergency brake). In those embodiments, the characteristic acoustic/vehicle dynamic signatures would be pre-programmed into the storage means and would include any signatures the system manufacturer seeks to detect.

A further example is a cockpit audio monitoring system that would constantly monitor voice stress levels and listen for characteristic speech patterns. These characteristic speech patterns, or characteristic acoustic signatures, could include but are not limited to those that are currently being monitored by law enforcement authorities and/or national intelligence agencies. The speech pattern would be applicable to the type of vehicle being monitored, e.g., an airplane cockpit monitoring circuit may be focused on prevention of an airplane hijacking. Sounds being constantly monitored would be identified, received and processed by the receiver, which entails comparing those sounds to known acoustic signatures indicated an impending threat. Using certain embodiments of this invention, if the receiver validates a match, the kill switch would automatically activate an emergency flight pattern governed by the applicable authorities so that the flight controls cannot be overtaken by a hijacker. The automatic pilot would then take over the flight controls to land the airplane under control at the nearest secure landing area.

Another example would be the case of an 18-wheel transport vehicle or bus. These are is slow accelerating but large vehicles capable of high speed on a highway. The acoustic and vehicle dynamic monitoring of these types of vehicles would be similar to that of a smaller automotive-type vehicle however, the control systems and algorithms would be modified to account for the large mass and inertia of this type of vehicles.

A still further example is off-road vehicles such as surface mining vehicles including hauling (dump) trucks or front-end loaders or sub-surface machines such as continuous miners. In these situations, workers may be in close proximity yet the operator of the vehicle may be unaware of the proximity of the co-workers either because of workplace noise, or the physics of massive vehicles and limited mirror/camera capability or the close quarters of sub-surface mine conditions.

According to the National Institute for Occupational Safety and Health, Mining Program in 2015, 40% of serious mining injuries involve struck-by or caught-in machinery and powered haulage equipment. Attempts have been made to use technology including GPS and radar, but have failed to reduce injury. The present method and systems, which are autonomous could be a major improvement. Acoustic and vehicle dynamic signatures related to mining dangers could be stored into the storage means and compared to sounds and vehicle dynamics continually collected during mining.

In this embodiment of the invention, during the operation of a mining vehicle if a present sound and vehicle dynamic matched with a sound waveform and vehicle signatures deemed dangerous, the receiver would send a signal to the electronic control module to quickly and safely arrest the mining vehicle. Once conditions are ascertained to be safe then operations may be continued. Unlike the vehicular pedestrian strike example, mining injuries are more likely to be accidents so the embodiment enabling the assailant to be held in the vehicle and the authorities notified is likely unnecessary.

One embodiment of the invention comprises an additional signal enhancement. The signal enhancement is the characteristic signal picked up by internal cabin microphones “hearing” the operator expressing known language to express determination or defiance consistent with language monitored by law enforcement and/or national intelligence agencies. The additional signal enhancement will trigger the system of the invention in one embodiment of the invention. In a more specific embodiment of the invention, the signal enhancement will activate the receiver to listen for further acoustic signals or motion signals, in accordance with the pre-programmed parameters stored therein.

In other specific embodiments of the invention, the housing means of the invention are encrypted. Encryption of the systems of the invention avoids theft of the algorithms and saved acoustic signatures that are saved within the storage means in the event the system is tampered with or copying is attempted. It is envisioned that some might seek to mitigate operation of the system by using the saved acoustic signatures that are indicative of vehicular attacks to produce acoustic means that would mask such sounds.

The systems and methods of the invention are adapted to control the threatening vehicle internally, whilst removing control of the vehicle from occupants. This invention is autonomous and without external communication, therefore when installed on a vehicle, there is no possibility of external takeover, i.e., the system anticipates hostile hacking using vulnerable wireless vehicle technology such as internet access, direction-finding, or Bluetooth. The systems are inaccessible remotely and inaccessible by the vehicle's occupants. In addition, the motion-detection technology that is capable of triggering the system is a fail-safe against external take-over. In the unlikely event that an unfriendly party were able neutralize sound waveforms, high gain vehicle dynamics cannot physically be blocked, thus, body motion cannot be effectively negated externally meaning the Autonomous Safety for Pedestrians technology is hardened against external threats.

For example, the invention includes the following embodiments:
1. A system for disabling a vehicle driven towards or into pedestrians in a safe and efficient manner, the vehicle itself including at least one monitoring system that includes at least one microphone, a motion-detection module composed of an accelerometer, and a vehicle operational control means (electronic control module), the system includes a central-processing unit, on a solid-state data storage mechanism, comprising:
a storage means for accepting and storing at least one acoustic signature and at least one vehicle motion signature, both in digital form;
a receiver in operable communication with the storage means, the receiver comprising a central processing unit therein, which is adapted to continually receive and
identify at least one present acoustic signature from at least one microphone and at least one present vehicle motion signature from the motion-detection module, then process the acoustic and motion signatures based on pre-programmed parameters stored within the central processing unit to determine whether at least one acoustic signal and one motion signal are indicative of a vehicular attack, and then transmit an action signal to a kill switch in the event the acoustic and motion signatures of a vehicular strike are confirmed;
a kill switch in operable communication with the receiver; the kill switch adapted to communicate with the vehicle electronic control module transmitting a signal thereto to disable the vehicle throttle and activate the brakes in response to a determination that at least one acoustic signature and one motion signature are indicative of a vehicular strike;
and a housing means adapted to connect the kill switch, storage means and receiver to one another, allow an incumbent connection to a vehicular power source for the system and provide a communicable connection between the electronic control unit and the system.
2. The system of embodiment 1, further comprising at least one anti-tamper mechanism adapted to disable the vehicle if and when there is an unauthorized attempt to remove the system from the vehicle.
3. The system of embodiment 1, wherein the characteristic acoustic signature is at least one of the sound waveforms including but not limited to those: originating inside a vehicle indicative of an intentional vehicular attack; sound waveforms related to a vehicle accessing a pedestrian-only area by traversing a curb as indicated by a high amplitude short-duration sound waveforms; vehicle body motion indicative of the vehicle impacting then rolling over an impediment and detectable with motion detection accelerometry in the CPU; sound waveforms resulting from the vehicle impacting pedestrian-area structures or pedestrians; sound waveforms of human voices indicating injury or panic; or sound waveforms indicating impending threats.
4. The system of embodiment 1, wherein the characteristic acoustic signature is at least one of the sound waveforms including but not limited to those: originating inside a mining vehicle indicative of an inadvertent vehicular strike; sound waveforms resulting from the vehicle impacting structures or pedestrians; human sound waveforms indicating injury or panic; vehicle body motion indicative of the vehicle impacting then rolling over an impediment and detectable with specific motion detection adapted especially for the vehicle, speeds and mining settings in the CPU.
5. The system of embodiment 3, wherein the sound waveforms originating inside the vehicle indicating a potential attack including human voices speaking specific words, irrespective of language, characteristic of an impending attack. The sound waveforms consistent with those monitored by law enforcement and/or national intelligence agencies.
6. The system of embodiment 1, wherein the housing means is encrypted.
7. The system of embodiment 1, wherein the central processing unit is adapted to remain continually autonomous.
8. The system of embodiment 1, further comprising non-optical means for detecting impending danger to pedestrians whether inadvertent or intentional.
9. The system of embodiment 1, further comprising a hard-shell casing adapted to allow operable communication between the system and the vehicle.
10. The system of embodiment 1, wherein the storage means is adapted to permanently store at least one characteristic acoustic signature and continually store the current environmental acoustic state at all times.
11. The system of embodiment 1, wherein the storage means is adapted to permanently store at least one characteristic vehicle motion signature using non-optical means and continually store the current vehicle motion state at all times.
12. The system of embodiment 1, wherein the vehicle operational control means is an electronic control module (black box) where vehicle engine and control systems are contained.
13. The system of embodiment 1, wherein the vehicle is one of a car, bus, airplane, tractor, train, or truck.
14. The system of embodiment 1, wherein the vehicle is a surface mining vehicle including hauling (dump) trucks, front-end loaders or sub-surface mining machines such as continuous miners.
15. The system of embodiment 1, further comprising a signal enhancement to complement the acoustic and vehicle dynamic data from the system.
16. The system of embodiment 1, wherein the kill switch, in response to a determination that the vehicle poses an impending threat, is adapted to direct the vehicle electronic control module
means to perform at least one of locking the vehicle access (door or doors), locking the vehicle window, alerting the authorities, providing visual alerts using the vehicle components, providing auditory alerts using the vehicle's components.
17. The system of embodiment 1, wherein the central processing unit is adapted to identify acoustic signatures that will trigger the receiver to process a present acoustic signature.
18. A system for disabling a vehicle driven towards or into pedestrians in a safe and efficient manner, the vehicle including at least one monitoring system that includes at least one microphone, and a motion detection module, and a vehicle electronic control unit, the system, on a solid-state storage mechanism, comprising:
a storage means for accepting and permanently storing at least one characteristic acoustic signature, at least one characteristic vehicle body motion-detection signature, and
temporarily storing at least one present acoustic signature and at least one present vehicle body motion signature, the characteristic acoustic signature being at least one of sound waveforms and the characteristic vehicle body motion signature being of a least one characteristic motion waveform. These may include sound waveforms originating inside a vehicle indicating a potential attack, sound waveforms resulting from the vehicle striking a curb, sound waveforms resulting from the vehicle impacting structures or striking pedestrians, sound waveforms from humans making characteristic sounds of fear, panic or pain, sound wave forms indicating an inadvertent mining equipment strike, or sound waveforms indicating impending threats. Indicators detected and stored may include violent vehicle body motions detected when the vehicle strikes curbs or impediments struck and rolled over while in the pedestrian walkway;
a receiver in operable communication with the storage means, the receiver comprising a central processing unit therein, which is adapted to continually identify and receive the at least one present acoustic signature from the at least one microphone, with at least one vehicle motion-detection signature from the motion detection module, and compare the present acoustic signature and motion signatures, based on pre-programmed parameters stored within the central processing unit, with the characteristic acoustic and motion signatures permanently pre-loaded into the storage means, to determine whether the signatures are indicative of a pedestrian strike, and transmit a distress signal to a kill switch in the event the acoustic and motion signals match; a kill switch in operable communication with the receiver and adapted to communicate with the vehicle electronic control module transmitting a signal thereto to disable the vehicle throttle in response to a determination that the at least one acoustic and one vehicle motion signal is indicative of a vehicular strike; an anti-tamper mechanism in communication with the kill switch, the antitamper mechanism adapted to render the vehicle unable to drive, if unauthorized removal of the mechanism is detected;
a housing means adapted to connect the kill switch, storage means and receiver to one another, allowing an incumbent connection to a vehicular power source for the system and provide a secure communicable connection between the vehicle electronic control module and the system; and
a hard-shell casing about the outer periphery of the housing means, wherein the inter-communication means and the storage means are encrypted, and wherein the system is autonomous.
19. A method for disabling a vehicle deliberately driven towards or into pedestrians in a safe and efficient manner, the method comprising the steps of:
identifying and accepting at least one characteristic acoustic signature and at least one characteristic vehicle motion signature into a storage means;
continually identifying and receiving at least one present acoustic signature from at least one microphone within the vehicle,
continually identifying and receiving at least one present vehicle motion signature from the motion-detection module within the vehicle,
comparing the present acoustic and motion signatures, based on pre-programmed parameters, to the characteristic acoustic and motion signatures to determine whether there is at least one acoustic signal and at least one motion signal indicative of a vehicular strike transmitting a distress signal to a kill switch in the event the acoustic and motion signals are indicative of a vehicular strike; and transmitting instructions to disable the vehicle to the vehicle electronic control module in response to a determination that the at least one acoustic signal and one vehicular motion signals are indicative of a vehicular strike.
20. The method of embodiment 19, wherein the characteristic acoustic signature is at least one of sound waveforms originating inside a vehicle indicating a potential attack, sound waveforms related to a vehicle accelerating over a curb and onto a pedestrian-only area, and sound waveforms resulting from the vehicle impacting structures or pedestrians, sound wave forms indicative of humans experiencing panic or injury, sound wave forms indicating an inadvertent pedestrian strike during above or below-ground mining, or sound waveforms indicating impending threats.
21. The method of embodiment 19, further comprising detection of vehicle motion indicative of an impending vehicular threat.
22. The method of embodiment 19, wherein disabling the vehicle comprises at least one of locking a vehicle's access doors, locking a vehicle's windows, sending auditory distress signals, sending visual distress signals, or contacting authorities.
23. The system of embodiment 18 or the method of embodiment 19 wherein the system or methods detects the sounds of approaching emergency vehicles and triggers a dashboard warning or an audible warning, providing instructions to the driver.
24. The method of embodiment 19, wherein, other changes-in-state are detected audibly (through the cabin microphone) or via the change in G-force via the vehicle dynamics accelerometer to determine the presence of a passenger (sleeping baby, for example) that warns the operator to check the vehicle for other occupants. Another example could be to prevent driverless movement (vehicle left in neutral or failure of the emergency brake).
25. The system of embodiment 18 comprising a cockpit audio monitoring system that constantly monitors voice stress levels and listen for characteristic speech patterns. These characteristic speech patterns, or characteristic acoustic signatures, could include but are not limited to those that are currently being monitored by law enforcement authorities and/or national intelligence agencies. The speech pattern would be applicable to the type of vehicle being monitored, e.g., an airplane cockpit monitoring circuit may be focused on prevention of an airplane hijacking. Sounds being constantly monitored would be identified, received and processed by the receiver which then compares those sounds to known acoustic signatures indicated as an impending threat. Using certain embodiments of this invention, if the receiver validates a match, the kill switch would automatically activate an emergency flight pattern governed by the applicable authorities so that the flight controls cannot be overtaken by a hijacker. The automatic pilot would then take over the flight controls to land the airplane under control at the nearest secure landing area.
26. A method of embodiment 19, wherein the system and methods are used to monitor an 18-wheel transport vehicle or bus. The acoustic and vehicle dynamic monitoring of these types of vehicles would be similar to that of a smaller automotive-type vehicle however, the control systems and algorithms would be modified to account for the large mass and inertia of this type of vehicles.

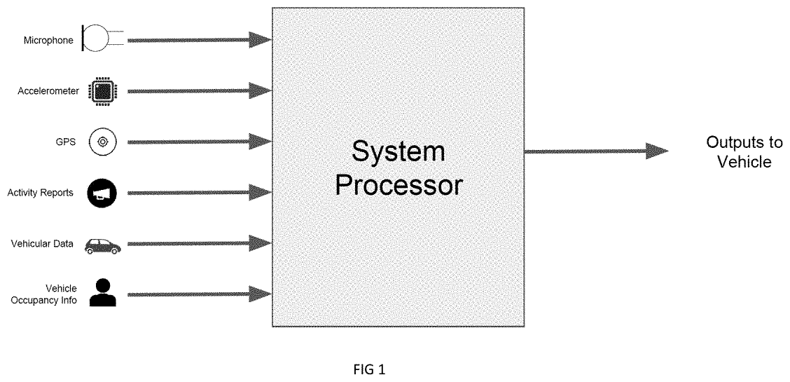

In a particular embodiment, the system has up to six data streams to make decisions and send out an output to a vehicle that would initiate certain actions to stop it from moving (such as turning on the engine and enabling the brakes). For example, the system may comprise microphone and accelerometer data. Additionally, as depicted in FIG. 1, the system may further comprise GPS, Activity Reports, Vehicular Data, and Vehicle Occupancy Information, all which provide data that can be integrated to further improve detection performance and will be collectively referred to as Auxiliary Data Streams. For example, the data streams may comprise
a) Microphone: This data stream is meant to pick up environmental sounds indicating that the vehicle is being misused, e.g. the sounds of people in distress, collisions, and taking the vehicle off-road.
b) Accelerometer: This data stream will pick up alterations in the XYZ coordinate system, to detect specific acceleration profiles of interest.
c) GPS: An optional data stream, GPS data will provide information on how populated the area is, and whether the vehicle is being driven in an area with high pedestrian traffic, for example pedestrian zones. If an attack is going to occur, it is unlikely it is being done in a rural area.
d) Activity Reports: Another optional data stream, Activity Reports are data from the internet alerting the system if the vehicle is entering an area with a high level of activity (such as public events, street fairs, concerts, etc.). In this case, an internet connection can be provided, e.g., by connecting to WiFi that the car may already have or via a cellular connection (3G, 4G, 5G).
e) Vehicular Data: Optional data stream, data from the vehicle itself, such as steering, braking, and throttle, and optionally on-board diagnostics Parameter ID (PID) data.
f) Vehicular Occupancy Data: Optional data stream, data telling of how many people are in the car and potentially the occupants of the vehicle.

For example, in some embodiments, the system comprises a processor which is a digital micro-computer, such as an ARM processor capable of running Linux, receiving data inputs from an accelerometer, microphone, and optionally one or more Auxiliary Data Streams, e.g. in a system as depicted in FIG. 1.

For example, digital streams of the microphone and accelerometer go into a processor where mathematical transformations are applied to them. Before that, they might need to go through an Analog-to-Digital Converter for the processor. At this stage, it is also useful to do some pre-processing to make an initial determination that the vehicle is being operated normally. If strange behavior is observed (e.g. high levels of acceleration) then the next step in processing proceeds. The reason for this is to reduce the incidence of false positives and also limit the load on the processor so in the case of an emergency event, it can detect the case much faster.

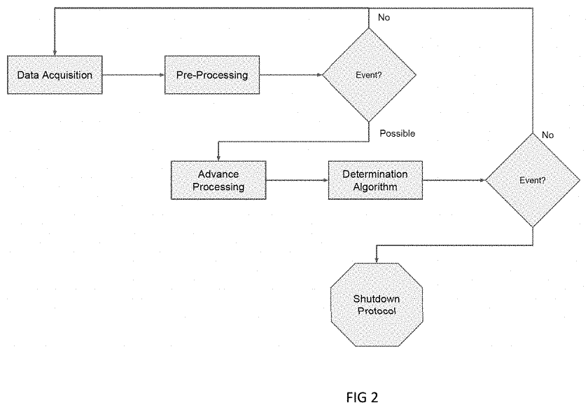

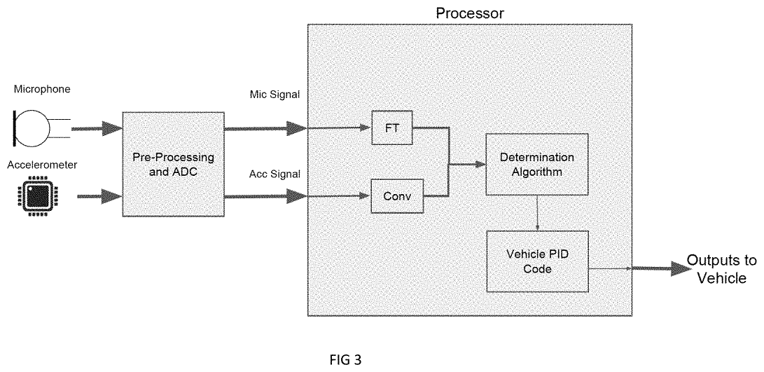

So, for example, as depicted in FIG. 2, the data is continually pre-processed to detect a potential event. If one or more of the data streams indicates a potential event, the data then undergoes advanced processing, and is submitted to a determination algorithm, which determines if there is an event, such that the vehicle should be shut down.

As depicted in FIG. 3, a Fourier transform or Fast Fourier transform (FT) may be used to process the microphone data, and the accelerometer data can similarly be passed through a convolution operation (a convolution is a general type of FT so a FT could alternatively be applied here as well). The convolution can be done with modeled data, acquired data, or other mathematical function. Similar to a convolution operation, cross-correlation methods can also be implemented to ensure signal fidelity. Ultimately, the results from the operations go into a determination algorithm that determines whether to follow a shutdown protocol. The shutdown protocol runs a script that picks out the vehicle specific PIDs to most quickly bring the vehicle to a stop. The processor can have one or multiple cores. If a single core is used, preference to one signal might be preferred (whichever signal is more reliable in determining an event) instead of having the processor try to work with both data streams at once. If the processor has multiple cores, the system can process both data streams at once by dedicating a core to each data stream. The determination algorithm can be as simple as a step-by-step process where if all conditions are met, the shutdown protocol is enacted. It can be more complicated, having a machine learning algorithm determining when to enact the protocol. This would require datasets to train a decision tree or a neural net.

In some embodiments, the system provides at least accelerometer data and microphone data. If a driver makes a wild steering change, that could be due to them swerving to avoid a collision. The accelerometer data would pick that up. The microphone, however, picks up on sounds made by pedestrians. If a driver is simply swerving to avoid a collision, the sounds of pedestrians would be absent.

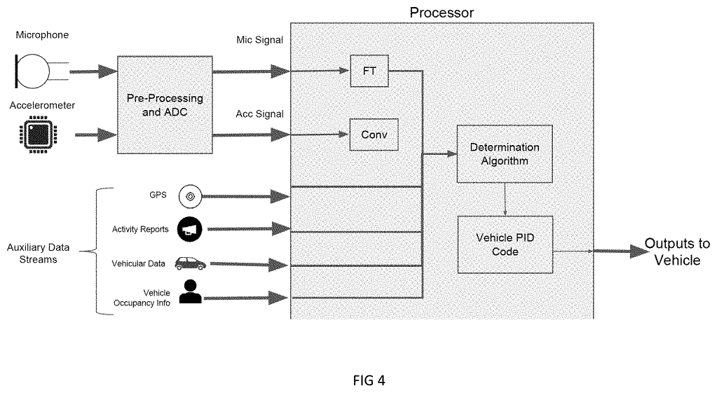

Adding one or more Auxiliary Data Streams provides additional information that can help the Determination Algorithm more accurately and, potentially, more quickly distinguish events. For example, as depicted in FIG. 4, a more complex determination algorithm is employed, to evaluate the additional data streams. Vehicular data can be used to correlate with the accelerometer data, adding a redundancy that could help reduce the number of false positives. GPS data and Activity Reports can help the system determine if strange behavior is occurring in an under-populated area or a densely-populated area. In under-populated areas, the threshold signal to shut down the vehicle could be higher relative to the signal in a highly-populated area, as the risk in an under-populated area is lower.

Vehicle Occupancy can also alert to an event. If the vehicle is in transit but there is a sudden change in vehicle occupancy, such as the driver exiting the vehicle while the vehicle is in motion, a shutdown sequence would be necessary.

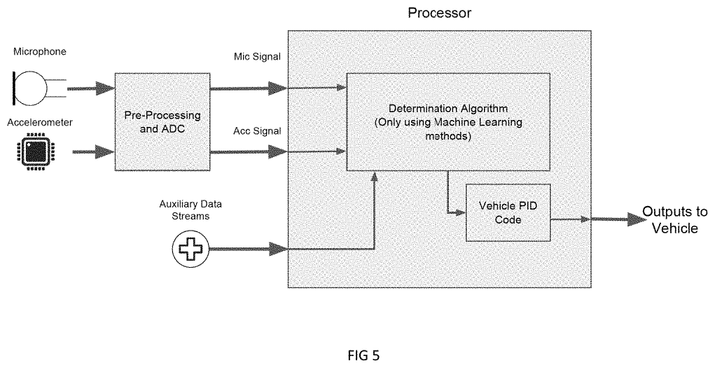

In certain embodiments, the Determination Algorithm which determines whether to shut down the vehicle is a machine learning algorithm, e.g., as depicted in FIG. 5.

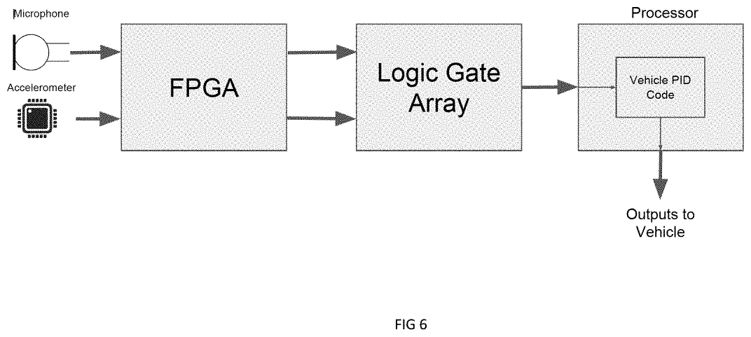

In certain embodiments, as depicted in FIG. 6, the system uses a field-programmable gate array (FPGA), which is an integrated circuit designed to be configured by a customer or a designer after manufacturing—hence the term “field-programmable”. The FPGA configuration may be specified using a hardware description language (HDL), similar to that used for an application-specific integrated circuit (ASIC). Using an FPGA avoids the necessity to turn the microphone or accelerometer data into digital signals, as those signals can be processed as described above (with a FT and Conv) but instead of being done digitally, this transformation can be optionally achieved completely with analog signals. The signals are transferred to a logic gate array that serves the same purpose as the determination algorithm but using analog signals. The logic gate array can be kept separate from the FPGA or can built in. The processor in this case is picks out the vehicles parameter identification (PID) codes. This processor can be a simple microcontroller and does not have to be as powerful as a micro-computer.

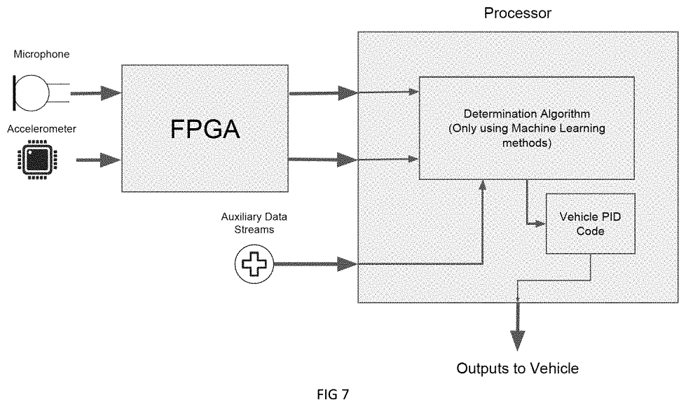

In certain embodiments, the system can use both a FPGA and a determination algorithm, e.g., as depicted in FIG. 7.

In certain embodiments, the system detects accelerator position, brake position, and irregular steering.

In certain embodiments, all inputs are internal to vehicle, e.g., the system does not rely on radar, sonar, or detection of objects in front of the vehicle.

In certain embodiments, the microphone data stream is analyzed for an acoustic signature corresponding to sound frequency, types of impact, and shouting or screaming.

In certain embodiments, the microphone is located outside of the passenger compartment of the vehicle.

In certain embodiments, there are microphones located at or near the front of the vehicle and at or near the rear of the vehicle, to detect an acoustic signature that is more pronounced at the front of the vehicle.

Thus, the invention provides, in certain embodiments:
a. A method of inhibiting misuse of a vehicle for terroristic purposes, comprising
   i. receiving data from a microphone, an accelerometer, and optionally one or more of a global positioning system, an activity report, vehicular data, and/or vehicle occupancy information;
   ii. detecting misuse of the vehicle by analyzing the data; and
   iii. shutting down the vehicle when misuse is detected.
b. Method (a) wherein analog data from the microphone and the accelerometer is converted to digital data.
c. Any foregoing method wherein detection of vehicle misuse is determined by a detection algorithm.
d. Method (c) wherein the determination algorithm is a machine learning algorithm.
e. Any foregoing method wherein vehicle misuse is characterized by at least:
   i. Microphone data indicating shouts or screams, and
   ii. Accelerometer data indicating sudden acceleration and sudden swerving.
f. Any foregoing method wherein the step of shutting down the vehicle is carried out by choosing vehicle specific parameter identifications (PIDs) to bring the vehicle to a stop.
g. Any foregoing method wherein the step of shutting down the vehicle is carried out by activating the vehicle brakes, cutting off the vehicle throttle and/or turning off the vehicle ignition.
h. Any foregoing method wherein the detection of vehicle misuse is determined by a field-programmable gate array (FPGA).
i. Any foregoing method wherein the detection of vehicle misuse is determined by a determination algorithm operating in conjunction with a field-programmable gate array (FPGA).

In another embodiment, the invention provides a system for operation of a method as described above, e.g.,
a. A system to inhibit misuse of a vehicle for terroristic purposes, wherein the vehicle is equipped with
   i. sensors comprising a microphone, an accelerometer, and optionally one or more of a global positioning system, a wireless internet receiver, sensors to detect, and/or sensors to detect vehicle occupancy, each of which sensors is transmissibly connected to
   ii. a processor programmed with a determination algorithm which determines vehicle misuse, which processor is operably linked to
   iii. the throttle, brakes and/or ignition of the vehicle, whereby the vehicle can be shut down by the processor if vehicle misuse is detected.
b. System (a) wherein the microphone and the accelerometer are each equipped with an analog to digital converter, so that data from the microphone and the accelerometer is transmitted to the processor in digital form.
c. Any foregoing System wherein the processor operates in conjunction with a field-programmable gate array (FPGA).

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements described as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability.

Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

1. A method of inhibiting misuse of a vehicle for terroristic purposes, comprising
i. receiving data from a microphone, an accelerometer, and optionally one or more of a global positioning system, an activity report, vehicular data, and/or vehicle occupancy information;
ii. detecting misuse of the vehicle by analyzing the data; and
iii. shutting down the vehicle when misuse is detected.

2. The method of claim 1 wherein analog data from the microphone and the accelerometer is converted to digital data.

3. The method of claim 1 wherein detection of vehicle misuse is determined by a detection algorithm.

4. The method of claim 3 wherein the determination algorithm is a machine learning algorithm.

5. The method of claim 1 wherein vehicle misuse is characterized by at least:
i. microphone data indicating shouts or screams, and
ii. accelerometer data indicating sudden acceleration and sudden swerving.

6. The method of claim 1 wherein the step of shutting down the vehicle is carried out by choosing vehicle specific parameter identifications (PIDs) to bring the vehicle to a stop.

7. The method of claim 1 wherein the step of shutting down the vehicle is carried out by activating the vehicle brakes and cutting off the vehicle throttle.

8. The method of claim 1 wherein the detection of vehicle misuse is determined by a field-programmable gate array (FPGA).

9. The method of claim 1 wherein the detection of vehicle misuse is determined by a determination algorithm operating in conjunction with a field-programmable gate array (FPGA).

10. A system to inhibit misuse of a vehicle for terroristic purposes, wherein the vehicle is equipped with
i. sensors comprising a microphone, an accelerometer, and optionally one or more of a global positioning system, a wireless internet receiver, sensors to detect, and/or sensors to detect vehicle occupancy, each of which sensors is transmissibly connected to
ii. a processor programmed with a determination algorithm which determines vehicle misuse, which processor is operably linked to
iii. the throttle, brakes and or ignition of the vehicle, whereby the vehicle can be shut down by the processor if vehicle misuse is detected.
